(19) United States
(12) Patent Application Publication
(10) Pub. No.: US 2026/0194786 A1
(43) Pub. Date: Jul. 9, 2026

(54) On-Chip Electro-Optic Device for Generating Frequency Comb

(71) Applicant: City University of Hong Kong, Hong Kong (HK)

(72) Inventors: Zhaoxi CHEN, Shenzhen (CN); Yiwen ZHANG, Hong Kong (HK); Cheng WANG, Hong Kong (HK)

(21) Appl. No.: 19/008,691

(22) Filed: Jan. 3, 2025

(51) Int. Cl. G02F 1/365; H01S 3/00; H01S 3/063; H01S 3/107

(52) U.S. Cl. CPC G02F 1/365; H01S 3/0085; H01S 3/063; H01S 3/107

(57) ABSTRACT

The present invention provides an on-chip electro-optic device for generating optical frequency comb. The device comprises: an optical racetrack resonator and a microwave modulation resonator electrode. The optical racetrack resonator includes: an optical coupling waveguide; and an optical ring resonant cavity optically coupled to the optical coupling waveguide to generate one or more optical modes from the optical light source and subject the one or more optical modes to a non-linear optical effect under a microwave modulation to generate the optical frequency comb. The microwave modulation resonator electrode includes: a microwave modulation resonant cavity configured to facilitate multiple electro-optic modulation on the one or more optical modes generated in the optical ring resonant cavity; and a microwave coupling port configured to couple a microwave signal into the microwave modulation resonant cavity. The provided frequency comb generator features better electrical field enhancement, less power consumption with negligible electrical power reflection.

### FIELD OF THE INVENTION

The invention is generally related to optical frequency comb (OFC) generation, and particularly related to on-chip electro-optic (EO) frequency comb generation based on coplanar waveguide microwave resonator electrode configuration.

### BACKGROUND OF THE INVENTION

OFC generators play crucial roles in various applications, including optical communications, spectroscopy, timekeeping, precise ranging, and exoplanet detections, by providing excellent light sources with coherent and equally spaced spectral lines. Among the various physical principles that are used for frequency comb generation, EO frequency comb generators are particularly attractive for its GHz repetition rates, broad tunability, and intrinsic mutual coherence. An EO frequency comb is generated by modulating a continuous-wave laser signal through one or multiple phase and amplitude EO modulators. This modulation process translates the input laser's single frequency into a comb of equally spaced frequency lines. Traditionally, EO comb generation is often achieved using off-the-shelf modulators based on lithium niobate (LiNbO₃, LN), a material well known for its excellent optical properties and significant χ⁽²⁾ nonlinearity. In recent years, the rapidly emerging thin-film LN (TFLN) platform, with tightly confined optical waveguides and substantially enhanced EO modulation efficiency, has further enabled integrated EO combs with much higher integration level and wider comb span compared with their bulk counterparts.

To date, most on-chip resonant EO frequency comb generators make use of a ground-signal-ground (GSG) capacitive electrode for applying the EO modulation signals (FIG. 1). This electrode configuration is essentially a lumped-capacitor load from the driving circuit perspective, where the input electrical power is almost fully reflected and not efficiently utilized. As a result, several watts of electrical driving power are often required for broadband EO comb generation. Moreover, the high reflected electrical power could be detrimental to the driving RF circuit, necessitating bulky and costly isolators or circulators to prevent power reflection to the electrical amplifier. In short, the lumped capacitor electrode design has become a major hurdle in terms of complexity, cost, and power consumption to the practical application of integrated resonant EO frequency comb generators.

### SUMMARY OF THE INVENTION

To address above-said issues, the present invention provides an EO frequency comb generator based on an on-chip coplanar waveguide (CPW) quarter-wave (λ/4) microwave resonator electrode configuration for efficient and RF-circuit friendly signal driving.

According to a first aspect of the present invention, an on-chip electro-optic device for generating optical frequency comb is provided. The device comprises: an optical racetrack resonator and a microwave modulation resonator electrode. The optical racetrack resonator includes: an optical coupling waveguide having an input optically coupled to an optical light source and an output configured to supply the optical frequency comb; and an optical ring resonant cavity optically coupled to the optical coupling waveguide to generate one or more optical modes from the optical light source and subject the one or more optical modes to a non-linear optical effect under a microwave modulation to generate the optical frequency comb. The microwave modulation resonator electrode includes: a microwave modulation resonant cavity configured to facilitate multiple electro-optic modulation on the one or more optical modes generated in the optical ring resonant cavity; and a microwave coupling port configured to couple a microwave signal into the microwave modulation resonant cavity. The microwave modulation resonant cavity includes a coplanar waveguide transmission line configured for phase-matching the microwave signal with the optical light source. The microwave coupling port is a coplanar waveguide coupling port electrically coupled to the coplanar waveguide transmission line.

According to a second aspect of the present invention, an on-chip electro-optic device for generating optical frequency comb is provided. The device comprises: an optical racetrack resonator and a microwave modulation resonator electrode. The optical racetrack resonator includes: an optical coupling waveguide having an input optically coupled to an optical light source and an output configured to supply the optical frequency comb; and an optical ring resonant cavity optically coupled to the optical coupling waveguide to generate one or more optical modes from the optical light source and subject the one or more optical modes to a non-linear optical effect under a microwave modulation to generate the optical frequency comb. The microwave modulation resonator electrode includes: a dual microwave modulation resonant cavity configured to facilitate multiple electro-optic modulation on the one or more optical modes generated in the optical ring resonant cavity; and a microwave coupling port configured to couple a microwave signal into the dual microwave modulation resonant cavity. The dual microwave modulation resonant cavity includes a first and a second coplanar waveguide transmission lines, each configured for phase-matching the microwave signal with the optical light source. The microwave coupling port is a coplanar waveguide coupling port electrically coupled to the dual coplanar waveguide transmission line.

Compared with a conventional lumped-capacitor electrode, the provided frequency comb generator features a 3.6 times electrical field enhancement, which translates into more than 3 times reduction in power consumption with negligible electrical power reflection (−50 dB). Leveraging a wafer-scale TFLN platform, broadband power-efficient EO frequency comb generation is demonstrated with a repetition rate of 25.6 GHz and a frequency comb span exceeding 85 nm. Remarkably, this is achieved using an optical racetrack resonator with a moderate Q_{L}=8.5×10⁵, at a relatively low electrical driving power of 28.7 dBm, and without the use of electrical isolators or circulators. The design and analytical model can be readily extended to other frequencies, supporting power-efficient EO frequency comb generation with a wide range of target repetition rates.

### BRIEF DESCRIPTION OF THE DRAWINGS

Embodiments of the invention are described in more details hereinafter with reference to the drawings, in which:

FIG. 1 shows a schematic diagram of a conventional EO frequency comb generator based on lumped-capacitor electrode.

FIG. 2 shows a schematic diagram of an EO frequency comb generator in accordance with one embodiment of the present invention;

FIG. 3 shows a schematic of the EO frequency comb generator with more details about the microwave modulation resonator electrode and modulation sections of the optical ring resonant cavity;

FIG. 4 shows a schematic of an EO frequency comb generator based on a quarter-wave microwave resonant cavity;

FIG. 5 shows the working mechanism of the EO frequency comb generator;

FIG. 6A shows schematic of an EO frequency comb generator based on a shorted-end half-wave microwave resonant cavity; and FIG. 6B shows schematic of an EO frequency comb generator based on an open-end half-wave microwave resonant cavity;

FIG. 7 shows measured microwave response of the quarter-wave resonator designed at ~10 GHz;

FIG. 8 shows an equivalent circuit model of the short-circuited CPW quarter-wave resonator driven by external circuit with a source impedance of R_{L}=50 Ω;

FIGS. 9A to 9C show cross-sectional views along lines A, B and C in FIG. 4 respectively;

FIG. 10 shows a fabricated EO comb generators with a lumped-capacitor electrode as a reference;

FIG. 11 shows a CPW resonator electrode fabricated according to the present invention;

FIGS. 12A and 12B shows SEM images of the metallic bridges at the shorted terminals (in the area denoted as “A” in FIG. 8) and the IDF coupler (in the area denoted as “B” in FIG. 8) of the CPW resonator electrode respectively;

FIG. 13 shows the measured EO comb spectrum generated by the EO comb generators with the lumped-capacitor electrode, and the insets show the corresponding schematic diagram (left) and optical transmission spectrum (right);

FIG. 14 shows the measured EO comb spectrum generated by the EO comb generators with the CPW resonator electrode, and the insets show the corresponding schematic diagram (left) and optical transmission spectrum (right);

FIG. 15 shows the measured and calculated reflection coefficient from a CPW resonator electrode according to the present invention and the measured reflection coefficient of a reference lumped capacitor electrode;

FIG. 16 shows a partial schematic of a microwave modulation resonator electrode and modulation sections of an optical ring resonant cavity in accordance with another embodiment of the present invention;

FIGS. 17A to 17D show cross-sectional views along lines A, B, C and D in FIG. 16 respectively;

FIG. 18 shows a fabricated OE comb generator including a dual microwave modulation resonant cavity according to another embodiment of the present invention;

FIG. 19 shows an equivalent circuit model of the dual CPW resonator electrode driven by external circuit with a source impedance of R_{L}=50 Ω;

FIG. 20 shows measured and calculated reflection coefficient from the dual-resonator design electrode;

FIG. 21 shows the measured EO comb spectrum generated by the EO comb generators with the dual CPW resonator electrode, and the insets show the corresponding schematic diagram (left) and optical transmission spectrum (right).

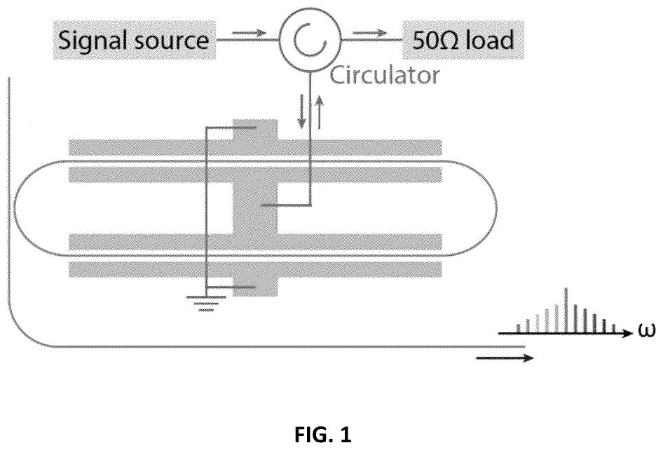

### DETAILED DESCRIPTION

In the following description, details of the present invention are set forth as preferred embodiments. It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

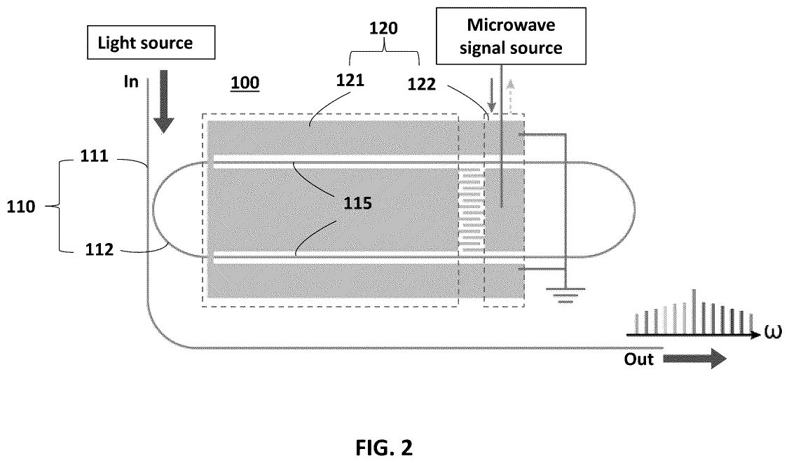

FIG. 2 shows a simplified schematic diagram of an EO frequency comb generator 100 in accordance with one embodiment of the present invention.

The EO frequency comb generator 100 comprises an optical racetrack resonator 110 including an optical coupling waveguide 111 and an optical ring resonant cavity 112.

The optical coupling waveguide 111 has an input optically coupled to an optical light source and an output configured to supply the optical frequency comb.

The optical ring resonant cavity 112 is optically coupled to the optical coupling waveguide 111 to generate one or more optical modes from the optical light source and subject the one or more optical modes to a non-linear optical effect under a microwave modulation to generate the optical frequency comb.

The EO frequency comb generator 100 further comprises a microwave modulation resonator electrode 120 including a microwave modulation resonant cavity 121 and a microwave coupling port 122.

The microwave modulation resonant cavity 121 is coupled to one or more modulation sections 115 of the optical ring resonant cavity 112 and configured to facilitate multiple electro-optic (EO) modulation on the one or more optical modes generated in the optical ring resonant cavity 112.

The microwave coupling port 122 is configured to couple a microwave signal from a microwave signal source into the microwave modulation resonant cavity 121.

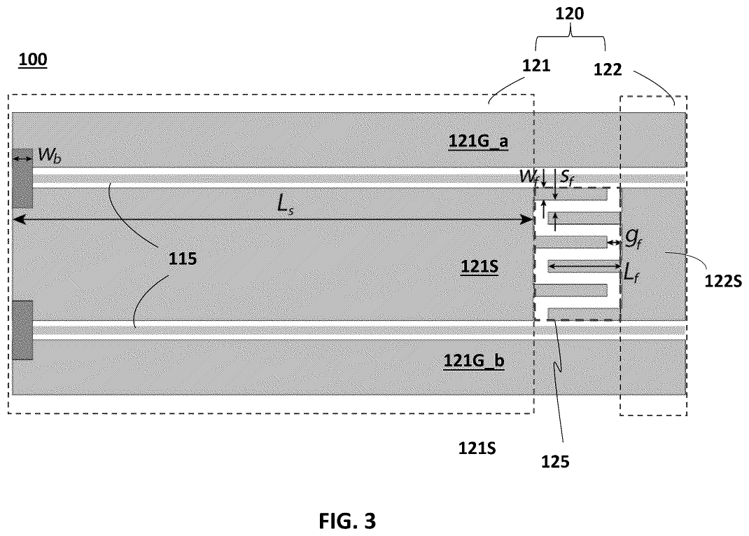

FIG. 3 shows a schematic of the EO frequency comb generator with more details about the microwave modulation resonator electrode 120 and modulation sections 115 of the optical ring resonant cavity.

The microwave modulation resonant cavity 121 of the microwave modulation resonator electrode 120 may be a coplanar waveguide transmission line arranged in a GSG configuration, including a signal strip 121S and a pair of upper and lower ground plates 121G_a and 121G_b spaced apart from an upper side and a lower side of the signal strip 121S respectively.

The modulation sections 115 of the optical ring resonant cavity 112 may include an upper modulation section 115a extending between the upper ground plate 121G_a and the signal strip 121S, and a lower modulation section 115b extending between the lower ground plate 121G_b and the signal strip 121S.

The microwave coupling port 122 may also be a coplanar waveguide arranged in a GSG configuration, including a signal pad 122S coupled to the signal strip 112S of the coplanar waveguide transmission line through an interdigitated finger (IDF) coupler 125.

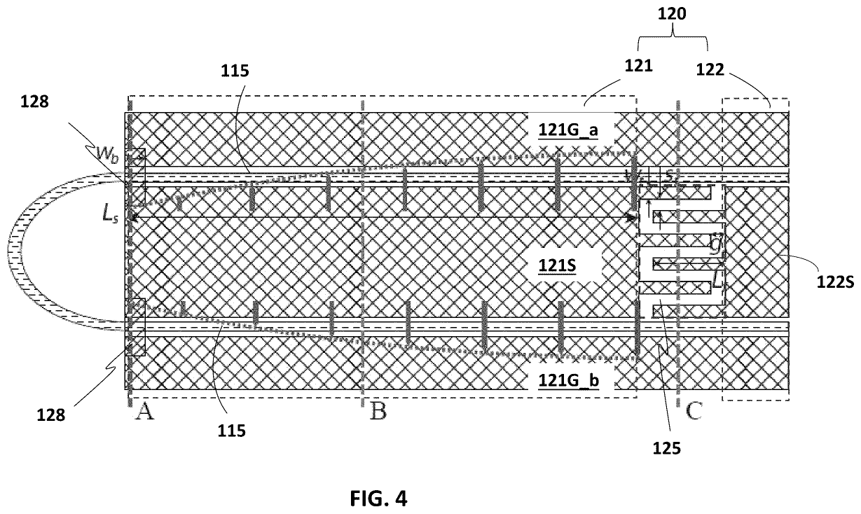

In some embodiments, the coplanar waveguide transmission line may have a length equal to a quarter wavelength of the microwave signal and shorted end 128 to form a quarter-wave (λ/4) resonant cavity as shown in FIG. 4.

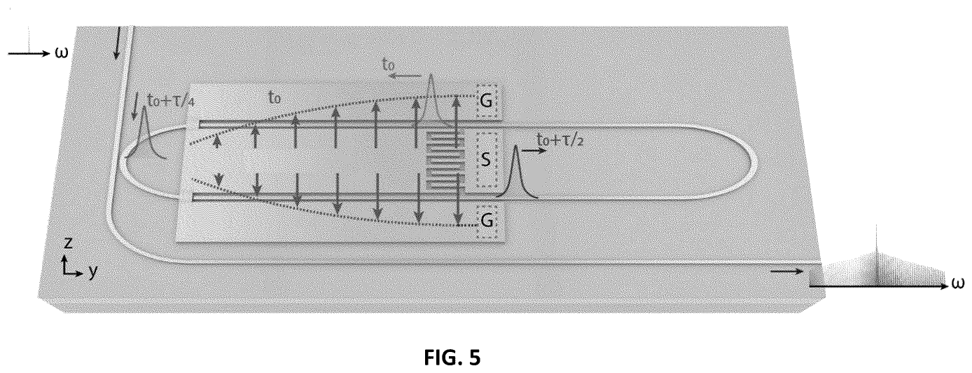

FIG. 5 shows the working mechanism of the EO frequency comb generator. When the frequency of the applied microwave signal is near the resonance frequency of the microwave resonator, the electrical field is significantly enhanced at the coupling (open) port, while the shorted end exhibits zero voltage (but finite current flow), following a sinusoidal λ/4 standing-wave pattern along the transmission line. Through precise engineering of the microwave electrode to achieve impedance matching between the microwave resonator and the driving circuit, the input electrical power can be critically coupled into the microwave modulation resonator electrode, leading to enhanced EO modulation efficiency and negligible reflected electrical power.

A crucial requirement to achieve efficient EO comb generation is phase matching between the resonant optical-waves and micro-waves. In the device architecture provided by the present invention, this is naturally satisfied when the microwave resonance frequency f_{MR}, applied microwave frequency f_{MW}, and the optical free-spectral range (FSR) are equal to each other.

Considering a counter-clockwise-traveling optical pulse present at the top middle section of the optical resonator at time to, it experiences a positive maximum EO modulation effect if the microwave field is pointing upwards (from signal to ground) at this point. The optical pulse circulates and reaches the bottom middle section of the optical resonator at time t₀+τ/2, where τ=1/FSR is the round-trip time of the optical resonator. Although the electric field at this location is opposite to that in the upper gap (pointing downwards at time to, as shown in FIG. 4), it exactly flips to the upward-pointing direction at t₀+τ/2, as long as the microwave modulation frequency f_{MW} is equal to the optical FSR (such that microwave period T_{MW}=1/f_{MW}=τ). As a result, the optical pulse again sees a positive maximum EO modulation field at t₀+τ/2. At other locations of the optical resonator, although the electric field strength may be smaller, the optical signal always experiences upward-pointing electric field and therefore a constructive accumulation of EO modulation throughout the optical resonator.

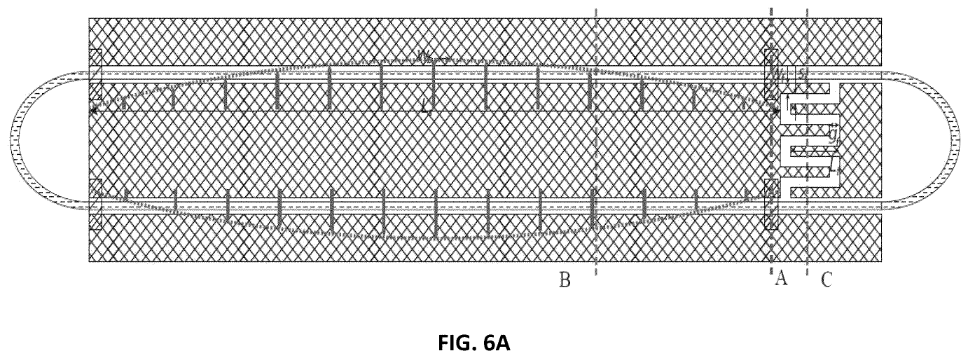

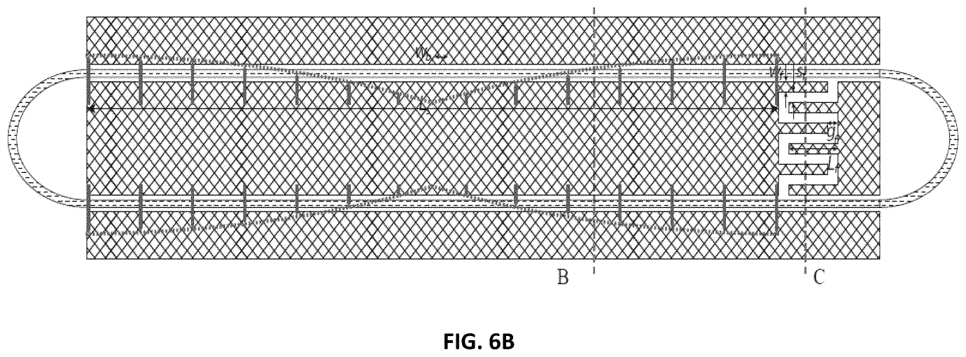

In some other embodiments, the microwave resonator may have a length of half the resonance wavelength, that is, a λ/2 resonator, as shown in FIGS. 6A and 6B. The λ/2 resonator can have short terminals (FIG. 6A) or open terminals (FIG. 6B), resulting in different amplitude distributions.

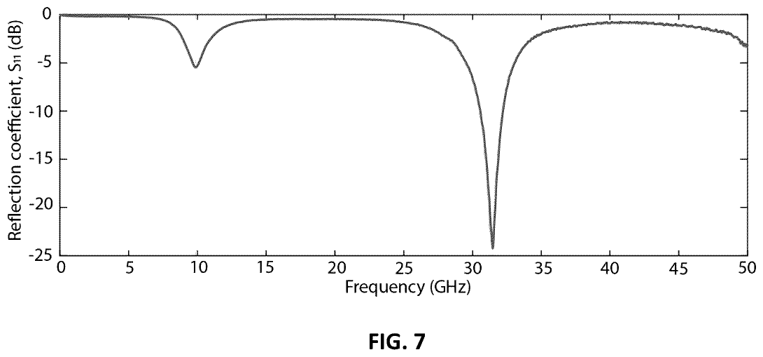

In the microwave resonators, the on-resonance amplitude distribution is determined by the terminal type (short or open). The electrical field is significantly enhanced at the open end, while the short end exhibits zero voltage. Although the current experiments only use the fundamental resonance mode, each microwave resonator has multiple higher-order resonance modes. For example, FIG. 7 shows the measured microwave response of the λ/4 resonator designed at ~10 GHz. Since the RF signal at higher frequency has shorter wavelength, the same resonator supports a high-order mode at ~30 GHz and serves as a 3λ/4 resonator. The same resonator can act as λ/4, 3λ/4, 5λ/4 . . . and has resonance at 10 GHz, 30 GHz, 50 GHz frequencies. Moreover, the multiple resonant frequencies also feature enhanced electrical fields.

On the other hand, an optical resonator has a FSR of 10 GHz can also be used for generating x0 GHz EO combs (x is an integer). The higher-order resonance mode of the microwave resonator can be used to achieve power-efficient EO comb generation with specified spectrum tailoring, by using single or multiple higher-order frequencies.

In one exemplary implementation, the microwave modulation resonator electrode may have an effective index (n_{eff,MW}) of ~2.6 and an effective wavelength of 4.4 mm, and a total length of 1.1 mm to achieve a λ/4 resonator targeting a repetition rate of ~25 GHz. Meanwhile, the optical racetrack resonator may consist of a TFLN waveguide with an optical group index (n_{g,O}) of 2.26 at telecommunication wavelengths and a round-trip length of 5.1 mm.

A bending radius of approximately 80 micrometers may be used with a Euler curve shape to minimize bending loss, such that the straight (or microwave modulation) section of the racetrack is 2.3 mm long. This allows the microwave λ/4 resonator to be placed within the left half of the optical resonator to satisfy the phase-matching condition discussed above.

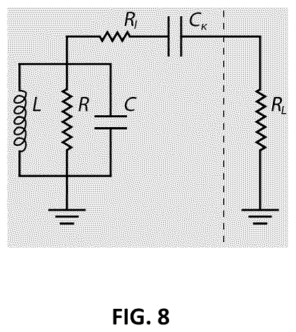

The short-circuit λ/4 resonator can be equivalently modeled by a parallel RLC resonant circuit near resonance (FIG. 8), where the input signal is applied from the driving circuit into the resonator circuit. Assuming there is no extra loss on the transmission line, the total input impedance of the resonator circuit is given by

$${Z}_{i n} = \frac{1}{i ω {C}_{κ}} + {R}_{l} + {Z}_{L C R} = \frac{1}{i ω {C}_{κ}} + {R}_{l} + {( \frac{1}{i ω L} + i ω C + \frac{1}{R} )}^{- 1}$$

where C_{κ} represents the capacitance of the IDF coupler, Rₗ is the parasitic resistance of the IDF coupler, and R, L and C are the equivalent resistance, inductance and capacitance of the RLC resonator, respectively.

It should be noted that the existence of the coupling capacitor not only changes the input impedance Zᵢₙ, but also shifts the resonance frequency f_{MR} from the isolated RLC resonance. As a result, the on-resonance impedance Zᵢₙ could be effectively controlled by fine tuning the coupling capacitance C_{κ}, and varying the IDF coupler length L_{f} to achieve a near 50Ω input impedance at the target frequency to match that of the external driving circuit and minimize power reflection.

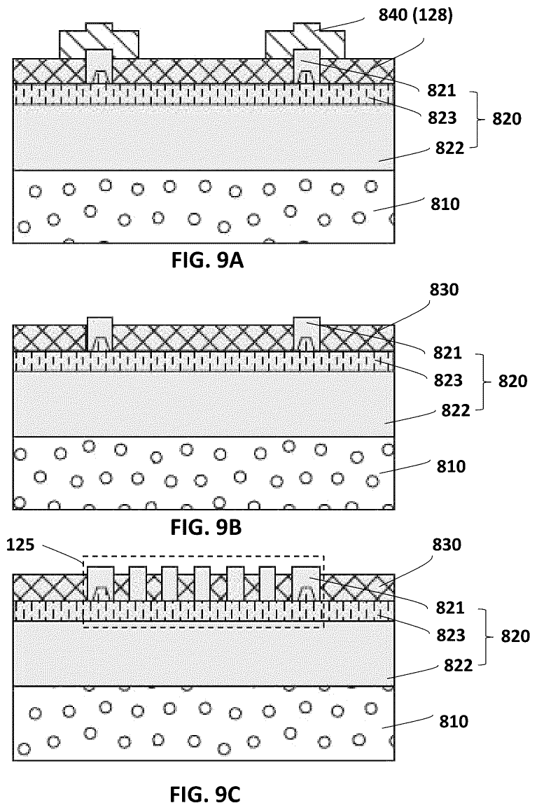

FIGS. 9A to 9C show cross-sectional views along lines A, B and C in FIG. 4 respectively. The EO frequency comb generator may comprise a substrate 810, a waveguide structure 820 including a light confinement layer 823 sandwiched between a first cladding layer 821 and a second cladding layer 822, and a conductive layer 830 on top of the waveguide structure 820. In some embodiments, an additional upper conductive layer 840 (FIG. 9A) may be deposited on top of the conductive layer 830 to form the shorted end 128. The substrate 810 may be made of silicon, sapphire, quartz or any suitable materials which may guide the microwave signal with low transmission loss in specific frequency region. The light confinement layer 823 may be made of a non-linear photonic material chosen from, but not limited to lithium niobate, lithium tantalate, and any suitable organic materials. The cladding layers 821 and 822 may be made of silicon oxide or any insulator having high transparency and relatively low refractive index that could support tightly confined optical modes. The conductive layers 830 and 840 may be made of conductive material chosen from, but not limited to, gold, copper, silver, aluminum, or any suitable materials which may guide the microwave signal with low transmission loss in specific frequency region.

In some embodiments, the on-chip EO frequency comb generator may be fabricated on a x-cut thin-film TFLN wafer. For example, a wafer stack consists of a 500-nm TFLN layer, a 4.7-μm thermal oxide buffer layer and a 500-μm high-resistance silicon substrate layer may be used. The bare wafer was first coated by a layer of 700 nm thick SiO₂ using plasma-enhanced chemical vapor deposition (PECVD) as etch mask. The optical waveguides and optical racetrack cavities are then patterned by an UV stepper lithography system. The patterns are transferred into the oxide mask layer and LN layer sequentially using reactive ion etching (RIE) with a 250 nm etch depth. After removing the remaining etch mask, another layer of PECVD oxide is coated to form a 1.5 μm thick upper cladding of the optical waveguides. The metallic electrodes (750 nm of copper, 50 nm of gold) are formed by a second stepper lithography process, followed by thermal deposition and lift-off. The signal strip has a width of 150 μm and the gap between signal strip and ground planes is set as 7 μm. Metallic bridges (800 nm of copper) having a width of 5 μm are then patterned at the shorted end of the microwave CPW resonator by electron-beam lithography (EBL), thermal deposition and lift-off processes. Finally, facets of the fabricated devices are cleaved for optical coupling. The fabricated optical bus waveguide has a top width of 1.2 μm and the racetrack has a width of 2 μm, and the racetrack bends are designed with Euler-curve shape to reduce radiation loss.

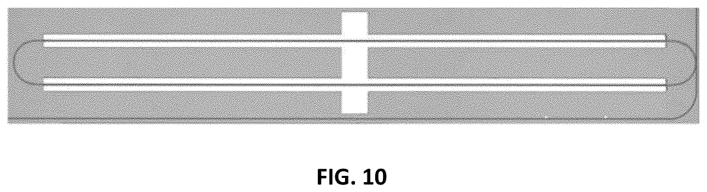

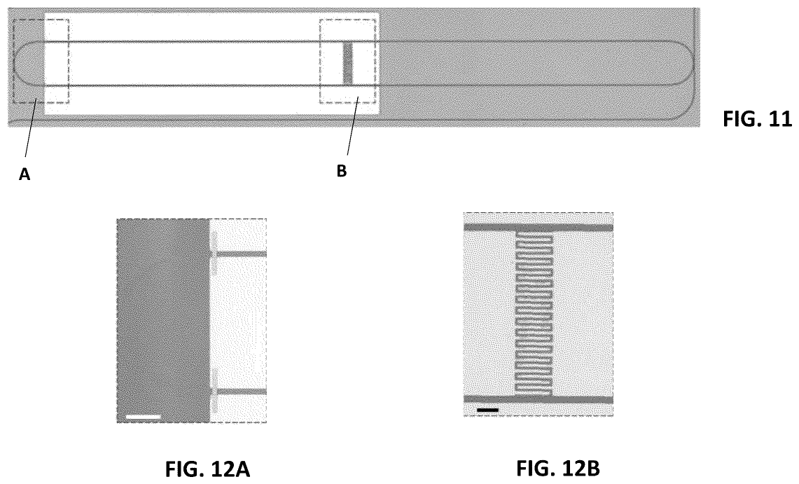

FIG. 10 shows a fabricated EO comb generators with a lumped-capacitor electrode as a reference. FIG. 11 shows a CPW resonator electrode fabricated according to the present invention. FIGS. 12A and 12B shows SEM images of the metallic bridges at the shorted terminals (in the area denoted as “A” in FIG. 11) and the IDF coupler (in the area denoted as “B” in FIG. 11) of the CPW resonator electrode respectively. The scale bars are 20 μm in both panels.

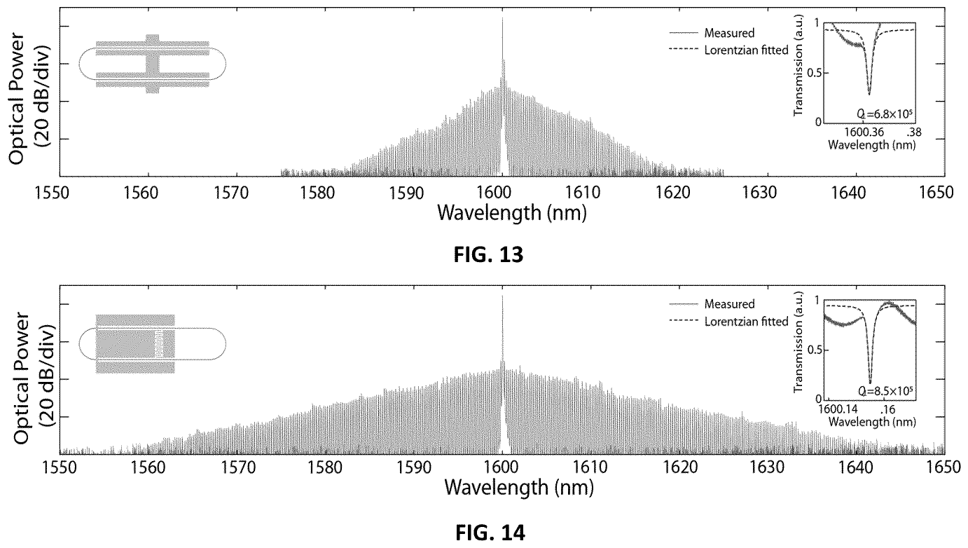

FIG. 13 shows the measured EO comb spectrum generated by the EO comb generators with the lumped-capacitor electrode, and the insets show the corresponding schematic diagram (left) and optical transmission spectrum (right). FIG. 14 shows the measured EO comb spectrum generated by the EO comb generators with the CPW resonator electrode, and the insets show the corresponding schematic diagram (left) and optical transmission spectrum (right). The measurement is performed by applying 2 mW optical pump and 740 mW (28.7 dBm) microwave driving power.

As shown, the CPW resonator electrode enables frequency comb generation with approximately doubled comb span from the reference lumped-capacitor electrode. When the input optical and microwave frequencies are both tuned into resonance with the on-chip optical and microwave resonators, broadband EO comb with an 85 nm span and 430 comb lines was achieved at a repetition rate of 25.612 GHz (FIG. 14). The measured spectral span and roll-off slope (~0.9 dB/nm) are both on par with that reported, but achieved using similar input RF power and an optical resonator with 1.8 times lower loaded Q_{L} factor (Q_{L}=8.5×10⁵). The modulation enhancement factor is further corroborated using the measured EO comb from the reference device fabricated on the same chip, which features a comb span of 38 nm (narrower by a factor of 2.2) with a repetition rate of 25.255 GHz (FIG. 13).

Considering the signal length of the CPW resonator electrode which is approximately half (1100 μm) of that in the lumped-capacitor electrode (2300 μm), it is estimated that the average electric field strength in the EO modulation region is enhanced by a factor of 3.6 in the microwave resonator. It should be also noted that, operating the comb generator provided by the present invention in a moderate-Q-factor regime also offers distinct advantages for practical applications, as the overall pump-to-comb conversion efficiency is ~0.6% and the system is less prone to optical and microwave detuning.

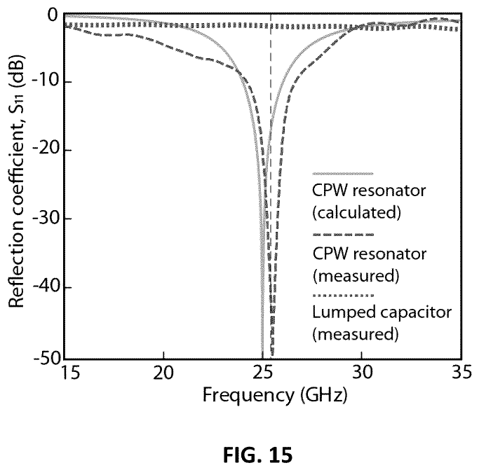

FIG. 15 shows the measured and calculated reflection coefficient S₁₁=|(Zᵢₙ−R_{L})/(Zᵢₙ+R_{L})|, from a CPW resonator electrode according to the present invention and the measured reflection coefficient of a reference lumped capacitor electrode. The fabricated CPW resonator electrode includes an IDF coupler with a finger length of 33.5 μm.

Ideally, the response should be zero at 25 GHz. The measured results are also consistent with the calculation results from the equivalent circuit model, where the slight discrepancy may result from deviations in the geometric dimensions and dielectric constants between theory and actually fabricated devices.

Remarkably, the power reflection could remain <−20 dB (less than 1%) within a relatively broad frequency range of 1 GHz, which provides crucial tolerance and flexibility in practical applications where the optical FSR may not be perfectly aligned with the microwave resonance. The fabricated EO comb generator operates at a repetition rate of 25.612 GHz (dashed line), where the power reflection is −46 dB. This is in sharp contrast to the lumped-capacitor case with a −3 dB power reflection into the driving circuit (rest is lost in the on-chip resistance).

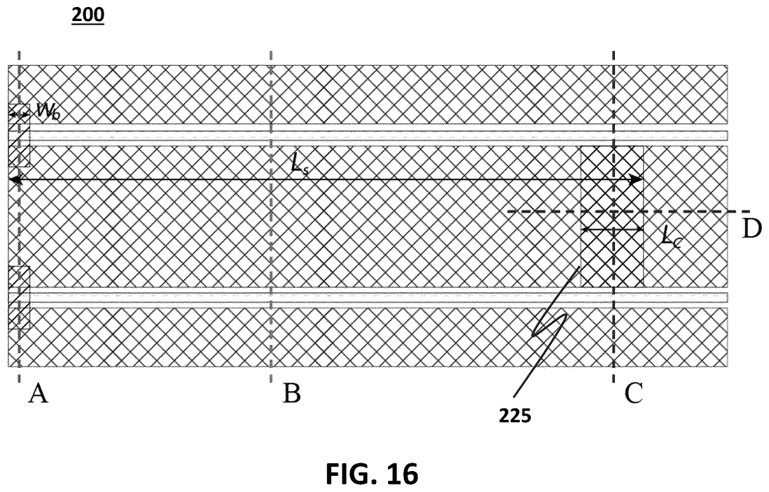

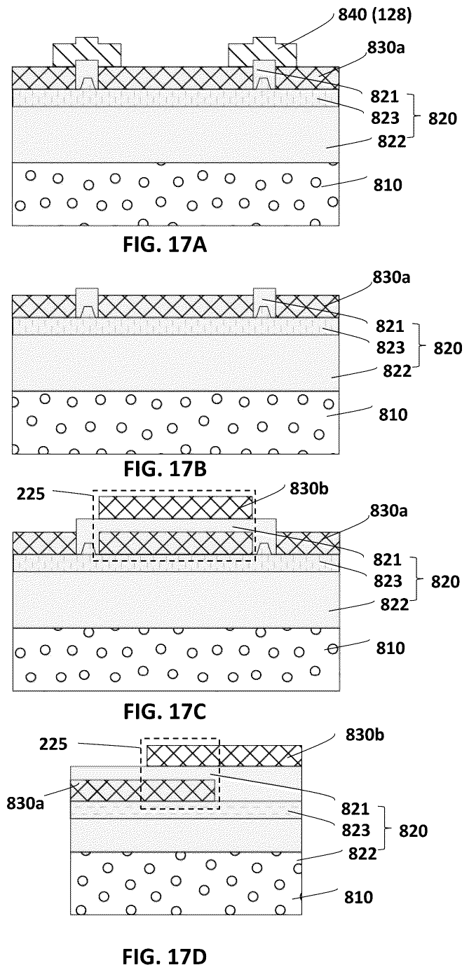

FIG. 16 shows a partial schematic of a microwave modulation resonator electrode and modulation sections of an optical ring resonant cavity 200 in accordance with another embodiment of the present invention. FIGS. 17A to 17D show cross-sectional views along lines A, B, C and D in FIG. 16 respectively.

The microwave modulation resonator electrode and the optical racetrack resonator of this embodiment is similar to the embodiment of FIG. 4 except for that the coplanar waveguide signal pad of the coupling port is coupled to the signal strip of the coplanar waveguide transmission line through a paralleled-plate capacitive coupler (or a coupling capacitor) 225. As shown in FIGS. 17C and 17D, the coupling capacitor 225 may be formed above the light confinement layer 823, including a bottom conductive plate 830a deposited on the light confinement layer 823, a top conductive plate 830b deposited on the top cladded silicon oxide layer 821 such that parts of the top cladded silicon oxide layer 821 being sandwiched as an insulator between the bottom and top conductive plates 830a and 830b.

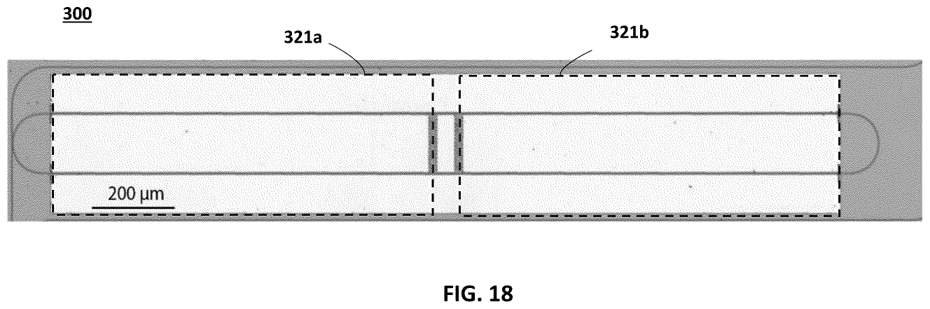

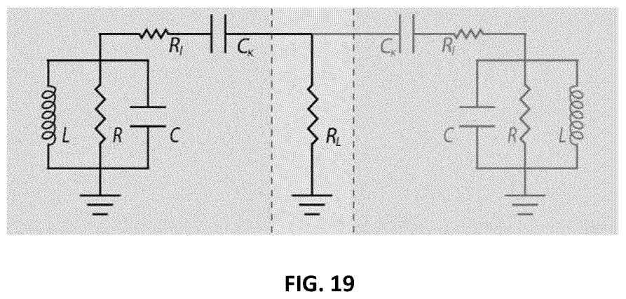

In some embodiments, the CPW resonator electrode may be expanded to have a dual-resonator design to further enhance the EO comb generation process by increasing the EO modulation length. FIG. 18 shows a fabricated EO comb generator 300 including a dual microwave modulation resonant cavity according to another embodiment of the present invention. The dual microwave modulation resonant cavity has a first and a second coplanar waveguide transmission lines 321a and 321b, each with a length equal to a quarter wavelength of the microwave signal and a shorted end to form a quarter-wave resonant cavity. A symmetrical circuit may be applied on the opposite side of the microwave driving circuit sharing the same coupling port as shown in FIG. 19.

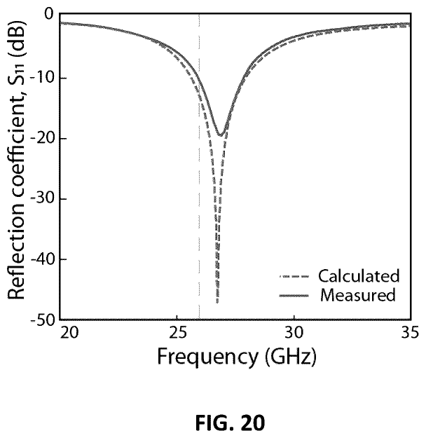

To achieve impedance matching in the dual-resonator circuit, the target impedance of each resonator circuit must be equal to 100Ω, keeping the overall input impedance as 50Ω at 25-GHz resonance frequency. Without changing the characteristics of the RLC resonators, the 100Ω impedance can be achieved by applying a smaller coupling capacitance C_{κ}. Microwave response of dual-resonator design electrode is shown in FIG. 20, where the critical coupling point occurs at finger length L_{f}=23 μm while the signal length Lₛ is unchanged as 1100 μm. After fabrication, the measured microwave response agrees well with the analytical model, featuring a resonance at 26.8 GHz with reflection coefficient down to −20 dB.

Similarly, the CPW resonator electrode using paralleled-plate coupling capacitor as coupler, may also be expanded to have a dual-resonator design to further enhance the EO comb generation process by increasing the EO modulation length.

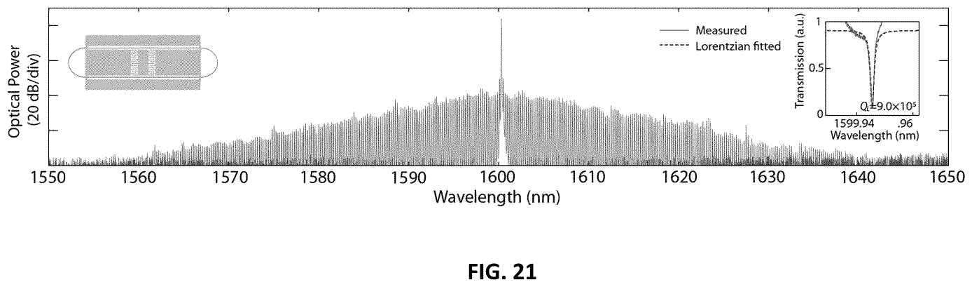

The EO comb generator using the dual-resonator design is experimentally measured by applying 2 mW optical pump and 740 mW (28.7 dBm) microwave driving power, same as when measuring the CPW resonator and lumped capacitor devices. As shown in FIG. 21, it is observed that a total number of 400 comb lines spaced by 25.7 GHZ, spanning ~80 nm from the device with dual-resonator electrodes. Compared with the lumped capacitor electrode, this result shows twice wide comb span, indicating a significant enhancement in EO modulation efficiency.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. An on-chip electro-optic device for generating an optical frequency comb, comprising:
an optical racetrack resonator, including:
an optical coupling waveguide having an input optically coupled to an optical light source and an output configured to supply the optical frequency comb; and
an optical ring resonant cavity optically coupled to the optical coupling waveguide to generate one or more optical modes from the optical light source and subject the one or more optical modes to a non-linear optical effect under a microwave modulation to generate the optical frequency comb; and
a microwave modulation resonator electrode, including:
a microwave modulation resonant cavity configured to facilitate multiple electro-optic modulation on the one or more optical modes generated in the optical ring resonant cavity; and
a microwave coupling port configured to couple a microwave signal into the microwave modulation resonant cavity; and
wherein the microwave modulation resonant cavity includes a coplanar waveguide transmission line configured for phase-matching the microwave signal with the optical light source; and
wherein the microwave coupling port is a coplanar waveguide coupling port electrically coupled to the coplanar waveguide transmission line.

2. The on-chip electro-optic device according to claim 1, wherein each of the coplanar waveguide transmission line and the coplanar waveguide coupling port is arranged in a GSG configuration.

3. The on-chip electro-optic device according to claim 2, wherein a signal terminal of the coplanar waveguide transmission line is coupled to a signal pad of the coplanar waveguide coupling port through an interdigitated finger coupler.

4. The on-chip electro-optic device according to claim 2, wherein a signal terminal of the coplanar waveguide transmission line is coupled to a signal pad of the coplanar waveguide coupling port through a plate capacitive coupler.

5. The on-chip electro-optic device according to claim 1, wherein the optical ring resonant cavity is a waveguide formed of a non-linear photonic material.

6. The on-chip electro-optic device according to claim 1, wherein the coplanar waveguide transmission line has a length equal to a quarter wavelength of the microwave signal and a shorted end to form a quarter-wave resonant cavity.

7. The on-chip electro-optic device according to claim 1, wherein the coplanar waveguide transmission line has a length equal to a half wavelength of the microwave signal and a shorted end to form a shorted half-wave resonant cavity.

8. The on-chip electro-optic device according to claim 1, wherein the coplanar waveguide transmission line has a length equal to a half wavelength of the microwave signal and an open end to form an open half-wave resonant cavity.

9. An on-chip electro-optic device for generating an optical frequency comb, comprising:
an optical racetrack resonator, comprising:
an optical coupling waveguide including an input optically coupled to an optical light source and an output configured to supply the generated optical frequency comb; and
an optical ring resonant cavity optically coupled to the optical coupling waveguide to generate one or more optical mode at a resonance wavelength; and
a microwave modulation resonator electrode, comprising:
a dual microwave modulation resonant cavity configured to facilitate multiple electro-optic modulation on the one or more optical modes generated in the optical resonator ring; and
a microwave coupling port configured to couple a microwave signal into the dual microwave modulation resonant cavity;
wherein the dual microwave modulation resonant cavity includes a first and a second coplanar waveguide transmission lines, each configured for phase-matching the microwave signal with the optical light source; and
wherein the microwave coupling port is a coplanar waveguide coupling port electrically coupled to the dual coplanar waveguide transmission line.

10. The on-chip electro-optic device according to claim 9, wherein each of the first and second coplanar waveguide transmission lines and the coplanar waveguide coupling port is arranged in a GSG configuration.

11. The on-chip electro-optic device according to claim 10, wherein a signal terminal of the first coplanar waveguide transmission line is coupled to a signal pad of the coplanar waveguide coupling port through a first interdigitated finger coupler; and a signal terminal of the second coplanar waveguide transmission line is coupled to the signal pad of the coplanar waveguide coupling port through a second interdigitated finger coupler.

12. The on-chip electro-optic device according to claim 10, wherein a signal terminal of the first coplanar waveguide transmission line is coupled to a signal pad of the coplanar waveguide coupling port through a first plate capacitive coupler; and a signal terminal of the second coplanar waveguide transmission line is coupled to the signal pad of the coplanar waveguide coupling port through a second plate capacitive coupler.

13. The on-chip electro-optic device according to claim 9, wherein the optical ring resonant cavity is a waveguide formed of a non-linear photonic material.

14. The on-chip electro-optic device according to claim 9, wherein each of the first and second coplanar waveguide transmission lines has a length equal to a quarter wavelength of the microwave signal and a shorted end to form a quarter-wave resonant cavity.

15. The on-chip electro-optic device according to claim 9, each of the first and second coplanar waveguide transmission lines has a length equal to a half wavelength of the microwave signal and a shorted end to form a shorted half-wave resonant cavity.

16. The on-chip electro-optic device according to claim 9, wherein each of the first and second coplanar waveguide transmission lines has a length equal to a half wavelength of the microwave signal and an open end to form an open half-wave resonant cavity.
